(19) United States
(12) Patent Application Publication
(10) Pub. No.: US 2017/0231380 A1
(43) Pub. Date: Aug. 17, 2017

(54) HAIR BRUSH WITH DOUBLE-SIDED COMB TEETH

(71) Applicant: Che Hsi Yang, Taichung (TW)

(72) Inventor: Che Hsi Yang, Taichung (TW)

(21) Appl. No.: 15/043,608

(22) Filed: Feb. 14, 2016

(51) Int. Cl. A46B 15/00; B25G 1/10; A45D 24/18; A46B 5/02

(52) U.S. Cl. CPC A46B 15/0059; A46B 5/02; B25G 1/102; A45D 24/18

(57) ABSTRACT

A hair brush with double-sided comb teeth includes two comb teeth portions with different types of comb teeth arranged and implanted on both upper and lower surfaces of an elastic clip cushion of the hair brush respectively, and a multiple of through holes formed at the periphery of the elastic clip cushion and provided for positioning. With the effects of a brush handle and a cover frame, the elastic clip cushion is clamped at a receiving slot of the brush handle, and the total area of the elastic clip cushion is slightly greater than the area of the receiving slot of the brush handle, and one of the end surfaces of the elastic clip cushion may be arched into an arc shape and the other end surface is naturally formed into a corresponding arc recession. The comb teeth portion with the arched surface is used as a hair brush, and the comb teeth portion with the recession is situated in a concealed status. When a user wants to switch the comb teeth portions, the user simply applies an appropriate pushing force to change the originally ached end surface into the recession, so as to complete the switch of the comb teeth portions.

### BACKGROUND OF THE INVENTION

(a) Field of the Invention

The present invention relates to the structure of a hair brush with double-sided comb teeth, more particularly to a single hair brush having two different types of comb teeth portions on two sides of the hair brush, so that users may change sides quickly anytime as needed, and thus this invention provides a convenient and practical application.

(b) Description of the Related Art

In general, a hair brush comes with one comb teeth portion only, and users usually have to buy several hair brushes of various different comb teeth portions and switch the brushes for the purposes to meet the user requirements of hairstyle, hair quality, hair quantity, personal using habit and special purposes (such as rubbing the scalp, blow-drying, and hairdressing) at different time. Such using mode does not cause too much inconvenience to user indoors, but users have to carry several hair brushes with them when they go out or travel, and it is a problem.

With reference to FIGS. 9 and 10 for a conventional hair brush with an elastic cushion, the conventional hair brush is comprised of an elastic cushion 10 with a single-sided comb teeth portion 11 and a brush handle 20 with a corresponding closed embedding slot 21, and the total area of the elastic cushion 10 is slightly greater than an accommodating space 22 of the embedding slot 21, so that after the elastic cushion 10 is installed into the embedding slot 21, and the contact edge is glued, an end surface of the comb teeth portion 11 of the elastic cushion 10 is arched naturally into an arc shape, so as to constitute the structure of a hair brush with single-sided comb teeth.

Although such conventional hair brush is advantageous in both manufacturing and assembling costs and favored by consumers and widely used by consumers, the design of the single-sided comb teeth portion of the conventional hair brush fails to meet the cost-effective and user requirements and thus requires further improvements.

### SUMMARY OF THE INVENTION

Therefore, it is a primary objective of the present invention to provide a hair brush with different types of comb teeth implanted on both upper and lower surfaces of an elastic clip cushion of the hair brush, and a receiving slot formed on a brush handle, so that both sides of the elastic clip cushion may be used as two different types of hair brushes by carrying out the steps of a simple and easy switching procedure. The present invention not just improves the practical application and extend the combing function only, but also reduces the number of required hair brushes to meet the cost-effective and practical requirements.

According to the invention, a hair brush with double-sided comb teeth includes two comb teeth portions with different types of comb teeth arranged and implanted on both upper and lower surfaces of an elastic clip cushion of the hair brush respectively, and a multiple of through holes formed at the periphery of the elastic clip cushion and provided for positioning. With the effects of a brush handle and a cover frame, the elastic clip cushion is clamped at a receiving slot of the brush handle, and the total area of the elastic clip cushion is slightly greater than the area of the receiving slot of the brush handle, and one of the end surfaces of the elastic clip cushion may be arched into an arc shape and the other end surface is naturally formed into a corresponding arc recession. The comb teeth portion with the arched surface is used as a hair brush, and the comb teeth portion with the recession is situated in a concealed status. When a user wants to switch the comb teeth portions, the user simply applies an appropriate pushing force to change the originally ached end surface into the recession, so as to complete the switch of the comb teeth portions.

### BRIEF DESCRIPTION OF THE DRAWINGS

The accomplishment of this and other objects of the invention will become apparent from the following description and its accompanying drawings of which:

FIG. 1 is a perspective exploded view of a first embodiment of the invention;

FIG. 2 is a perspective assembly view of the first embodiment of the invention according to FIG. 1;

FIG. 3 is a perspective assembly view of the first embodiment of the invention according to FIG. 2 (in use);

FIG. 4 is a perspective view of a second embodiment of the invention;

FIG. 5 is a perspective view of a third embodiment of the invention;

FIG. 6 is a perspective view of a fourth embodiment of the invention;

FIG. 7 is a perspective view of the fourth embodiment of the invention;

FIG. 8 is a perspective view of a fifth embodiment of the invention;

FIG. 9 is a perspective exploded view of a conventional hair brush with an elastic cushion; and

FIG. 10 is a perspective assembly view of the conventional hair brush according to FIG. 9.

### DETAILED DESCRIPTION OF THE PREFERRED EMBODIMENT

The technical measures and characteristics of the present invention will become clearer in light of the following detailed description of an illustrative embodiment of this invention described in connection with the drawings.

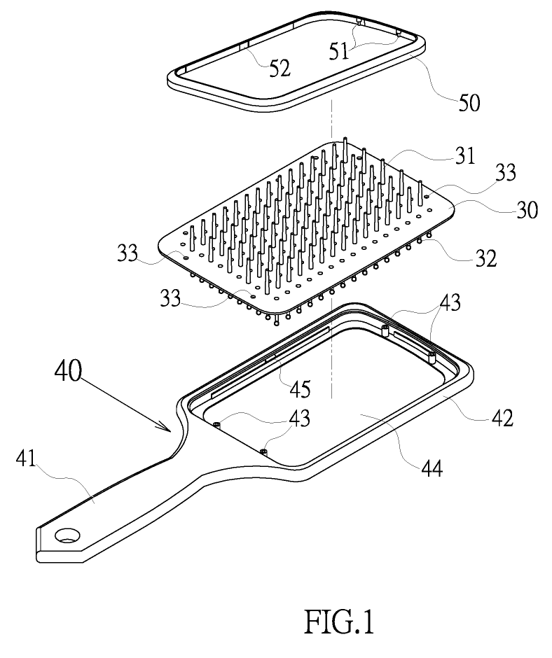

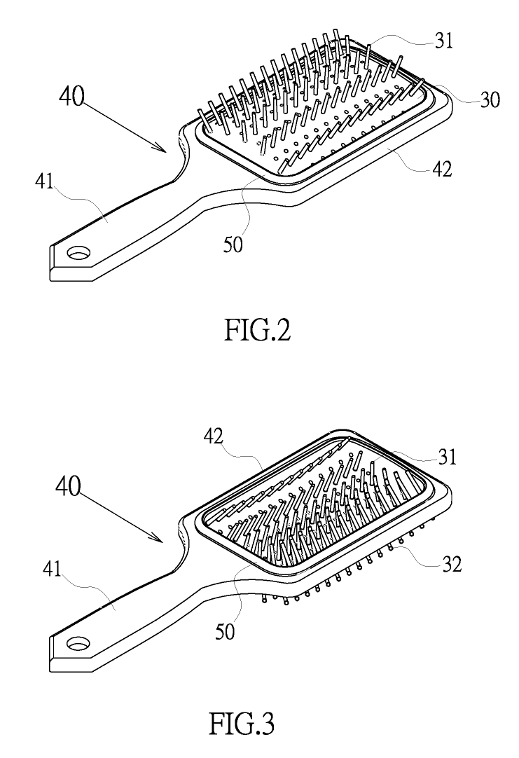

With reference to FIGS. 1 to 3 for the schematic views of assembling, operating and using a hair brush with double-sided comb teeth in accordance with a preferred embodiment of the present invention, the hair brush comprises an elastic clip cushion 30, a brush handle 40 and a cover frame 50.

The elastic clip cushion 30 includes a comb teeth portion 31, 32 with a different type of comb teeth arranged and implanted separately on both upper and lower surfaces of the elastic clip cushion 30, and a plurality of through holes 33 formed at the periphery of the elastic clip cushion 30 for the purpose of positioning.

The brush handle 40 has an end being a holding end 41 and the other end being a combing end 42, and an engaging hole 43 is formed at an inner edge of the combing end 42 and configured to be corresponding to the through hole 33 of the elastic clip cushion 30, and the combing end 42 further has a receiving slot 44, wherein the total area of the receiving slot 44 is slightly smaller than the elastic clip cushion 30, and the receiving slot 44 further has an embedding plate 45 disposed separately on both sides of the receiving slot 44.

The cover frame 50 is provided for covering the combing end 42 of the brush handle 40, and has a corresponding latching pillar 51 and a corresponding embedding slot 52 disposed on an inner side of the periphery of the cover frame 50 and latched into the corresponding engaging hole 43 and the corresponding embedding plate 45 of the combing end 42 to combine the two securely.

With the aforementioned components, the combing end 42 of the brush handle 40 and the corresponding engaging hole 43 and latching pillar 51 of the cover frame 50 may be used together with the through holes 33 of the elastic clip cushion 30 to clamp and fix the elastic clip cushion 30 to the receiving slot 44 of the brush handle 40, so that one of the end surfaces of the elastic clip cushion 30 is arched into an arc shape, and the other end surface of the elastic clip cushion 30 is naturally formed into a corresponding arc recession. The comb teeth portion 31 with the arched surface may be used as a hair brush and the comb teeth portion 32 with the recess surface is situated in a concealed status. In FIG. 3, when a user wants to change the use of the comb teeth portion 31, 32, the user simply needs to apply an appropriate pushing force to change the originally arched end surface into a recession in order to achieve the purpose of changing the use of the comb teeth portion 31, 32 quickly.

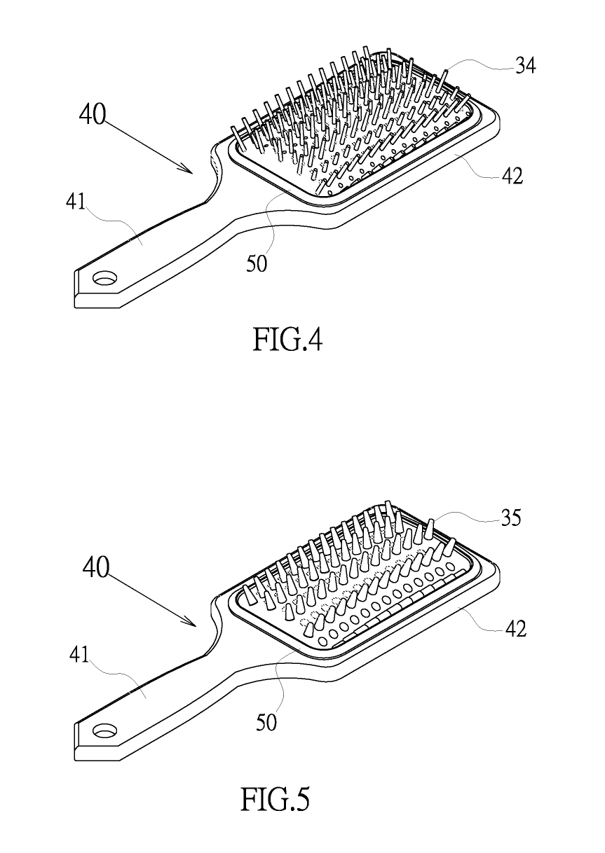

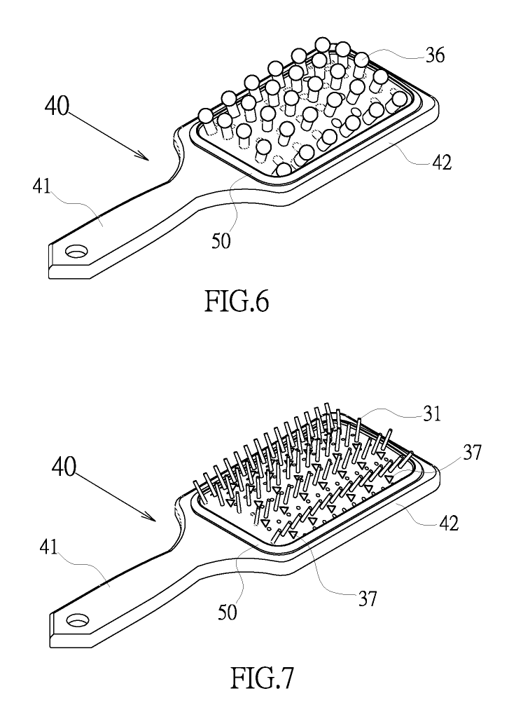

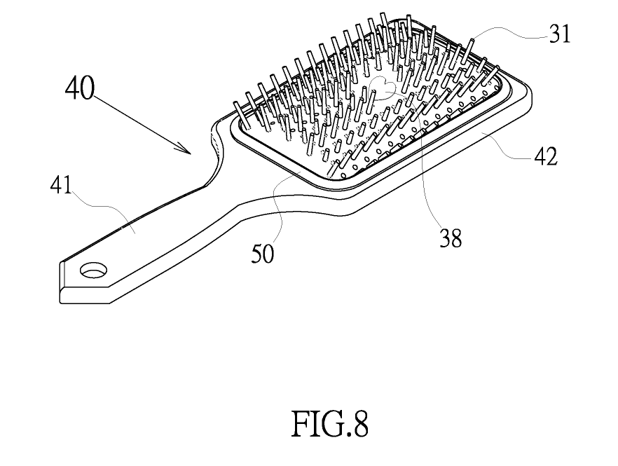

In summation, the present invention comes with two comb teeth portions 31, 32 disposed on both sides of the hair brush and configured to be in different modes, different lengths and different densities, and thus the invention is applicable to parallel comb teeth 34 of different lengths as shown in FIG. 4, conical comb teeth 35 as shown in FIG. 5, or bump type massaging comb teeth 36 as shown in FIG. 6. In FIG. 7, the elastic clip cushion 30 further has a plurality of air guide holes 37 formed at appropriate positions of the elastic clip cushion 30 and provided to be operated with a hair dryer (not shown in the figure), so as to form a special hair brush for hairstyling and improve the practical application of the invention.

Various different types of comb teeth may be applied to the present invention, so that the hair brush has a multiple of functions. In addition, each comb teeth portion 31, 32, 33, 34, 35, 36 disposed on the elastic clip cushion 30 may be manufactured by the method and operation of implanting pins, or integrally formed with the air guide holes 37a by injection molding, so as to minimize the manufacturing cost and complies with the expected objectives.

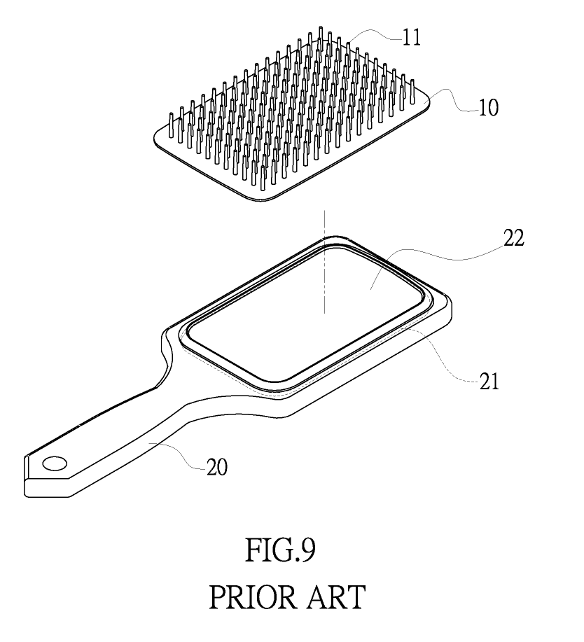

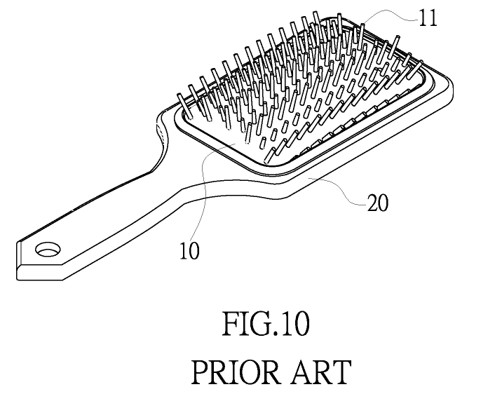

In FIG. 8, a tooth-free region 38 is defined at a position proximate to the comb teeth portion 31, 32 of the elastic clip cushion 30 and provided for a user to extend a finger into the tooth-free region 38 to change the comb teeth portion 31, 32 quickly.

Many changes and modifications in the above-described embodiments of the invention can, of course, be carried out without departing from the scope thereof Accordingly, to promote the progress in science and the useful arts, the invention is disclosed and is intended to be limited only by the scope of the appended claims.

What is claimed is:

1. A hair brush with double-sided comb teeth, comprising:
an elastic clip cushion, having a comb teeth portion with a different type of comb teeth arranged and implanted separately on both upper and lower surfaces of the elastic clip cushion, and a plurality through holes formed around the periphery of the elastic clip cushion and provided for positioning;
a brush handle, with an end being a holding end and the other end being a combing end, and having an engaging hole formed on an inner edge of the combing end and configured to be corresponding to the elastic clip cushion through hole, and a receiving slot formed at the combing end and having a total area slightly smaller than the elastic clip cushion, and an embedding plate installed at both sides of the receiving slot separately; and
a cover frame, for covering the combing end of the brush handle, and having a corresponding latching pillar and a corresponding embedding slot disposed on an inner side of the periphery of the cover frame and provided for latching to the corresponding engaging hole and the corresponding embedding plate of the combing end;
thereby, the elastic clip cushion is clamped at the receiving slot of the brush handle, and one of the end surface of the elastic clip cushion is arched into an arc shape and the other end surface of the elastic clip cushion is formed into a corresponding arc recession naturally, and the comb teeth portion with the arched surface may be used as a hair brush, the comb teeth portion with the arc surface is situated in a concealed status, and when it is necessary to switch the use of the comb teeth portion, an appropriate pushing force is applied to change the originally arched end surface into the recession to complete the effect of changing the use of the comb teeth portion.

2. The hair brush with double-sided comb teeth according to claim 1, further comprising a plurality of air guide holes formed at appropriate positions of the elastic clip cushion respectively.

3. The hair brush with double-sided comb teeth according to claim 1, further comprising a tooth-free region disposed at a position proximate to the center of the comb teeth portion of the elastic clip cushion.
